(19) United States
(12) Patent Application Publication
(10) Pub. No.: US 2017/0249120 A1
(43) Pub. Date: Aug. 31, 2017

(54) Sharing of Multimedia Content

(71) Applicant: Telefonaktiebolaget LM Ericsson (publ), Stockholm (SE)

(72) Inventors: Ari Keränen, Helsinki (FI); Heidi-Maria Back, Helsinki (FI); Dietmar Fiedler, Kirkkonummi (FI)

(21) Appl. No.: 15/507,149

(22) PCT Filed: Aug. 29, 2014
(86) PCT No.: PCT/SE2014/050998

§ 371 Date: Feb. 27, 2017

(51) Int. Cl. G06F 3/14; H04L 29/06

(52) U.S. Cl. CPC G06F 3/1462; H04L 65/403

(57) ABSTRACT

There is provided mechanisms for sharing multimedia content. A method performed by a sharing device comprises acquiring at least one of a current multimedia content segment and a current state of a screen sharing application executed by the sharing device. The method comprises determining, before a future multimedia content segment is rendered at the sharing device, a candidate multimedia content segment for the future multimedia content segment of the screen sharing application, wherein the candidate multimedia content segment is based on at least one of the current multimedia content segment and the current state of the screen sharing application and is determined from a limited set of possible candidate multimedia content segments. The method comprises generating and encoding the candidate multimedia content segment. The method comprises sending the generated and encoded candidate multimedia content segment to a receiving device before the future multimedia content segment is rendered at the sharing device.

### TECHNICAL FIELD

Embodiments presented herein relate to sharing multimedia content, and particularly to method, a sharing device, a receiving device, computer programs, and a computer program product for sharing multimedia content.

### BACKGROUND

In communications networks, there may be a challenge to obtain good performance and capacity for a given communications protocol, its parameters and the physical environment in which the communications network is deployed.

For example, screen sharing is a service in a communications network that enables two or more end-user devices to share content that is currently rendered on one of the end-user devices. In general terms, typical generic real-time or near real-time content sharing applications may capture a continuous stream of images of the screen or other content of the content sharing application at the sharing end-user device, encode that into an encoded bitstream, and send the bitstream to a receiving end-user device with which the content is shared. In order to achieve good performance, the bitstream needs to be encoded, transmitted, and decoded as fast as possible.

For certain content sharing applications, such as slide shows, the content sharing application of the sharing end-user device may send the whole material (e.g., a presentation) to the receiving end-user device and simply inform the receiving end-user device which slide to render and when to render it. This mechanism allows the content sharing application at the sharing end-user device to skip the generating and encoding phases for each individual slide and also enables the sharing end-user device to preemptively transfer bulk of the data. This results in a fast interaction between the sharing end-user device and the receiving end-user device.

As a further improvement, instead of transmitting all user actions as a video stream, some user interactions, such as mouse coordinates on a screen of a content sharing application, can be sent separately, see RFC2862; “RTP Payload Format for Real-Time Pointers”, June 2000.

In view of the above, generic mechanisms for content sharing applications thus require a substantial amount of bandwidth in order to achieve responsive real-time user experience. The responsiveness may be dictated by how fast the new screenshots, such as intra-coded frames for video-based content sharing applications, can be transferred to the receiving end-user device.

Sending new screenshots may be regarded as a trade-off between used bandwidth and the time it takes to show the change, as defined by the new screenshot, at the receiving end-user device. This creates peaks in the bandwidth when a fast and responsive update is required. Peaks in bandwidth are often regarded as disadvantageous for distributed network solutions since packets exceeding expected bandwidth are more often dropped on the way at routers or border gateway function (BGF) performing session bandwidth control.

Further, the approach disclosed above as used by slide sharing applications where the whole material (e.g., a slide presentation) is known beforehand (and can be transferred to the other endpoint before showing) applies only to a very small subset of content sharing applications.

Hence, there is still a need for improved mechanisms for sharing multimedia content.

### SUMMARY

An object of embodiments herein is to provide efficient mechanisms for sharing multimedia content.

According to a first aspect there is presented a method for sharing multimedia content. The method is performed by a sharing device. The method comprises acquiring at least one of a current multimedia content segment and a current state of a screen sharing application executed by the sharing device. The method comprises determining, before a future multimedia content segment is rendered at the sharing device, a candidate multimedia content segment for the future multimedia content segment of the screen sharing application, wherein the candidate multimedia content segment is based on at least one of the current multimedia content segment and the current state of the screen sharing application and is determined from a limited set of possible candidate multimedia content segments. The method comprises generating and encoding the candidate multimedia content segment. The method comprises sending the generated and encoded candidate multimedia content segment to a receiving device before the future multimedia content segment is rendered at the sharing device.

Advantageously this provides an efficient mechanism for sharing multimedia content.

Further advantageously, this enables screen sharing multimedia data to be sent preemptively and hence enables responsive screen sharing with lower bandwidth requirements.

Further advantageously, in situations with limited bandwidth (or expensive data transfer), the multimedia could be transferred to a cache before a last hop so that it is available as soon as the screen sharing application notifies the receiving device which multimedia content to show; and only those frames need to be transferred over the last hop.

Further advantageously, the bandwidth for sending changes to current multimedia content is more distributed over time and therefore results in a more constant bandwidth over time. The possibility that packets are dropped on the way may be lowered since peaks in traffic may be avoided.

According to a second aspect there is presented a sharing device for sharing multimedia content. The sharing device comprises a processing unit. The processing unit is configured to acquire at least one of a current multimedia content segment and a current state of a screen sharing application executed by the sharing device. The processing unit is configured to determine, before a future multimedia content segment is rendered at the sharing device, a candidate multimedia content segment for the future multimedia content segment of the screen sharing application, wherein the candidate multimedia content segment is based on at least one of the current multimedia content segment and a current state of the screen sharing application and is determined from a limited set of possible candidate multimedia content segments. The processing unit is configured to generate and encode the candidate multimedia content segment. The processing unit is configured to send the generated and encoded candidate multimedia content segment to a receiving device before the future multimedia content segment is rendered at the sharing device.

According to a third aspect there is presented a computer program for sharing multimedia content, the computer program comprising computer program code which, when run on a processing unit of a sharing device, causes the sharing device to perform a method according to the first aspect.

According to a fourth aspect there is presented a method for sharing multimedia content. The method is performed by a receiving device. The method comprises receiving a current multimedia content segment of a screen sharing application executed by a sharing device. The method comprises receiving a candidate multimedia content segment for a future multimedia content segment of the screen sharing application, the candidate multimedia content segment having been determined by the sharing device based on at least one of the current multimedia content segment and a current state of the screen sharing application and from a limited set of possible candidate multimedia content segments.

According to a fifth aspect there is presented a receiving device for sharing multimedia content. The receiving device comprises a processing unit. The processing unit is configured to receive a current multimedia content segment of a screen sharing application executed by a sharing device. The processing unit is configured to receive a candidate multimedia content segment for a future multimedia content segment of the screen sharing application, the candidate multimedia content segment having been determined by the sharing device based on at least one of the current multimedia content segment and a current state of the screen sharing application and from a limited set of possible candidate multimedia content segments.

According to a sixth aspect there is presented a computer program for sharing multimedia content, the computer program comprising computer program code which, when run on a processing unit of a sharing device, causes the receiving device to perform a method according to the third aspect.

According to a seventh aspect there is presented a computer program product comprising a computer program according to at least one of the third aspect and the sixth aspect and a computer readable means on which the computer program is stored.

It is to be noted that any feature of the first, second, third, fourth, fifth, sixth and seventh aspects may be applied to any other aspect, wherever appropriate. Likewise, any advantage of the first aspect may equally apply to the second, third, fourth, fifth, sixth, and/or seventh aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication system according to an embodiment;

FIG. 2a is a schematic diagram showing functional units of a sharing and/or receiving device according to an embodiment;

FIG. 2b is a schematic diagram showing functional modules of a sharing device according to an embodiment;

FIG. 2c is a schematic diagram showing functional modules of a receiving device according to an embodiment;

FIG. 3 shows one example of a computer program product comprising computer readable means according to an embodiment;

FIGS. 4, 5, 6, 7, and 8 are flowcharts of methods according to embodiments; and

FIGS. 9, 10, and 11 schematically illustrates transmission of multimedia segments according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

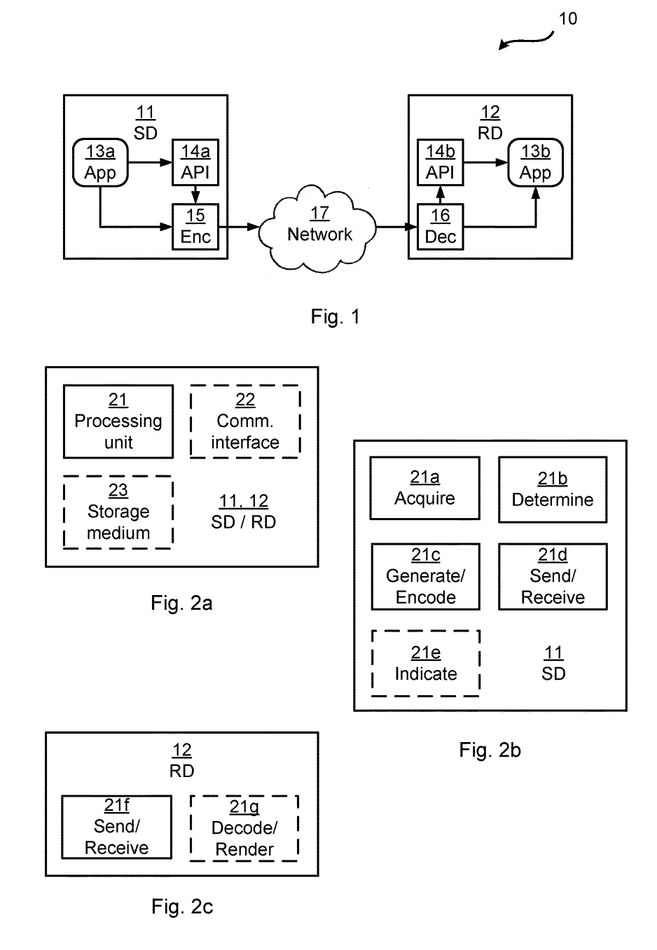

FIG. 1 is a schematic diagram illustrating a communications network 10 where embodiments presented herein can be applied. The communications network 10 comprises a sharing device (SD) 11 and a receiving device (RD) 12 configured to communicate over a network 17. The network 17 may be any combination of a wired and a wireless network. The sharing device 11 and the receiving device 12 may be implemented as portable end-user devices, such as mobile stations, mobile phones, handsets, wireless local loop phones, user equipment (UE), smartphones, laptop computers, tablet computers, or the like.

The sharing device 11 executes a screen sharing application 13a. The screen sharing application 13a interfaces an application programming interface (API) 14a and an encoder 15. Further, the API 14a interfaces the encoder 15. The receiving device 12 executes a screen sharing application 13b. The screen sharing application 13b interfaces an application programming interface (API) 14b and a decoder 16. Further, the API 14b interfaces the decoder 16.

The screen sharing application 13a may cause multimedia segments to be rendered. These multimedia segments are encoded by the encoder 15 and sent to the receiving device 12 where they are decoded by the decoder 16 and rendered by the screen sharing application 13b. The embodiments disclosed herein relate to sharing multimedia content. The herein disclosed sharing of multimedia content involves sending preemptively and probabilistically information about future multimedia segments of the screen sharing application 13a in order to increase responsiveness and enable improved quality of the sharing. The API 14a may therefore support sending preemptive multimedia segments and the API 14b may support receiving such multimedia segments.

In order to obtain such sharing of multimedia content there is provided a sharing device 11, a method performed by the sharing device 11, and a computer program comprising code, for example in the form of a computer program product, that when run on a processing unit of the sharing device 11, causes the sharing device 11 to perform the method. In order to obtain such sharing of multimedia content there is further provided a receiving device 12, a method performed by the receiving device 12, and a computer program comprising code, for example in the form of a computer program product, that when run on a processing unit of the receiving device 12, causes the receiving device 12 to perform the method

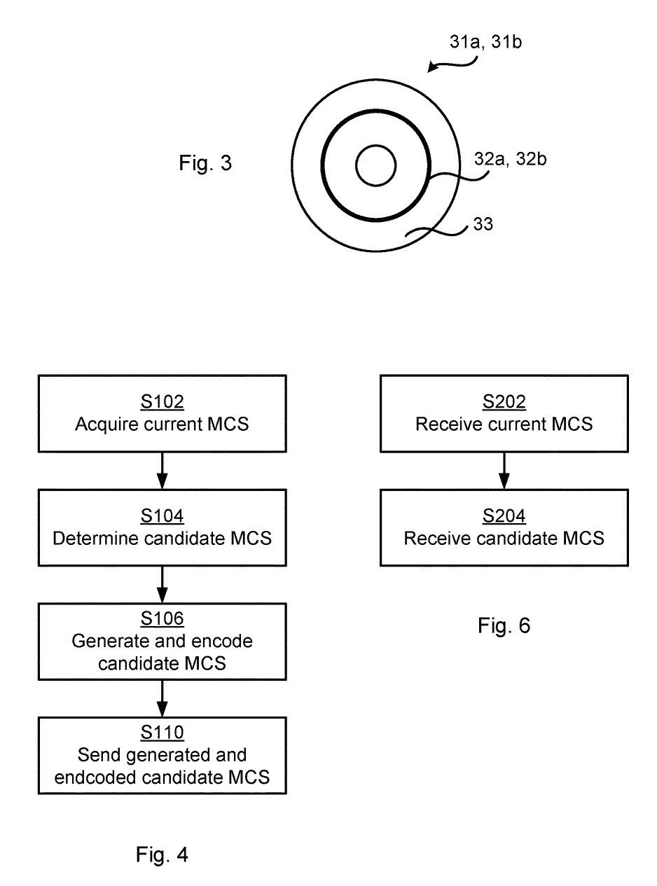

FIG. 2a schematically illustrates, in terms of a number of functional units, the components of a sharing device 11 and/or a receiving device 12 according to an embodiment. A processing unit 21 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 31a (as in FIG. 3), e.g. in the form of a storage medium 23. Thus the processing unit 21 is thereby arranged to execute methods as herein disclosed. The storage medium 23 may also comprise persistent storage, which, for example, can be any single one or combination of magnetic memory, optical memory, solid state memory or even remotely mounted memory. The sharing device 11 and/or a receiving device 12 may further comprise a communications interface 22 for communications with another sharing device 11 and/or a receiving device 12, possibly over a network 17. As such the communications interface 22 may comprise one or more transmitters and receivers, comprising analogue and digital components and a suitable number of antennae for radio communications and/or a suitable number of interfaces and ports for wired communications. The processing unit 21 controls the general operation of the sharing device 11 and/or a receiving device 12 e.g. by sending data and control signals to the communications interface 22 and the storage medium 23, by receiving data and reports from the communications interface 22, and by retrieving data and instructions from the storage medium 23. Other components, as well as the related functionality, of the sharing device 11 and/or a receiving device 12 are omitted in order not to obscure the concepts presented herein.

FIG. 2b schematically illustrates, in terms of a number of functional modules, the components of a sharing device 11 according to an embodiment. The sharing device 11 of FIG. 2b comprises a number of functional modules; an acquire module 21a, a determine module 21b, a generate and encode module 21C, and a send/receive module 21d. The sharing device 11 of FIG. 2b may further comprises a number of optional functional modules, such as an indicate module 21e. The functionality of each functional module 21a-e will be further disclosed below in the context of which the functional modules 21a-e may be used. In general terms, each functional module 21a-e may be implemented in hardware or in software. Preferably, one or more or all functional modules 21a-e may be implemented by the processing unit 21, possibly in cooperation with functional units 22 and/or 23. The processing unit 21 may thus be arranged to from the storage medium 23 fetch instructions as provided by a functional module 21a-e and to execute these instructions, thereby performing any steps as will be disclosed hereinafter.

FIG. 2c schematically illustrates, in terms of a number of functional modules, the components of a receiving device 12 according to an embodiment. The receiving device 12 of FIG. 2b comprises a send/receive module 21f. The receiving device 12 of FIG. 2c may further comprise a number of optional functional modules, such as a decode and render module 21g. The functionality of each functional module 21f-g will be further disclosed below in the context of which the functional modules 21f-g may be used. In general terms, each functional module 21f-g may be implemented in hardware or in software. Preferably, one or more or all functional 21f-g may be implemented by the processing unit 21, possibly in cooperation with functional units 22 and/or 23. The processing unit 21 may thus be arranged to from the storage medium 23 fetch instructions as provided by a functional module 21f-g and to execute these instructions, thereby performing any steps as will be disclosed hereinafter.

The sharing device 11 and/or a receiving device 12 may be provided as a standalone device or as a part of a further device. For example, the sharing device 11 and/or a receiving device 12 may be provided in an end-user device such as a portable wireless device, a laptop computer, a tablet computer, or the like.

FIG. 3 shows one example of a computer program product 31a, 31b comprising computer readable means 33. On this computer readable means 33, a computer program 32a can be stored, which computer program 32a can cause the processing unit 21 and thereto operatively coupled entities and devices, such as the communications interface 22 and the storage medium 23, to execute methods for sharing multimedia content as performed by a sharing device 11 according to embodiments described herein. On this computer readable means 33, a computer program 32b can be stored, which computer program 32b can cause the processing unit 21 and thereto operatively coupled entities and devices, such as the communications interface 22 and the storage medium 23, to execute methods for sharing multimedia content as performed by a receiving device 12 according to embodiments described herein. The computer program 32a, 32b and/or computer program product 31a, 31b may thus provide means for performing any steps as herein disclosed.

In the example of FIG. 3, the computer program product 31a, 31b is illustrated as an optical disc, such as a CD (compact disc) or a DVD (digital versatile disc) or a Blu-Ray disc. The computer program product 31a, 31b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 32a, 32b is here schematically shown as a track on the depicted optical disk, the computer program 32a, 32b can be stored in any way which is suitable for the computer program product 31a, 31b.

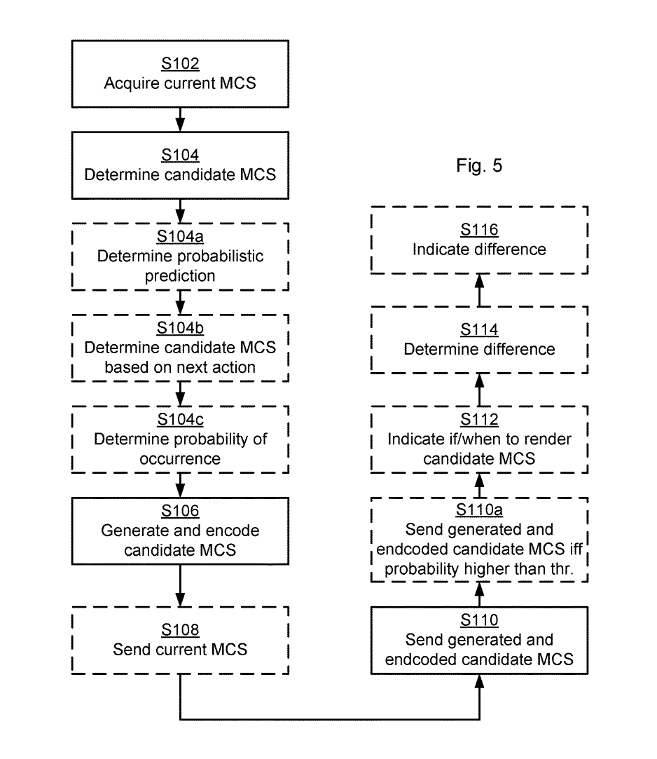

FIGS. 4, 6, and 8 are flow chart illustrating embodiments of methods for sharing multimedia content. The methods are performed by the sharing device 11. The methods are advantageously provided as computer programs 32a. FIGS. 5, 7, and 8 are flow chart illustrating embodiments of methods for sharing multimedia content. The methods are performed by the receiving device 12. The methods are advantageously provided as computer programs 32b.

Reference is now made to FIG. 4 illustrating a method for sharing multimedia content as performed by a sharing device 11 according to an embodiment.

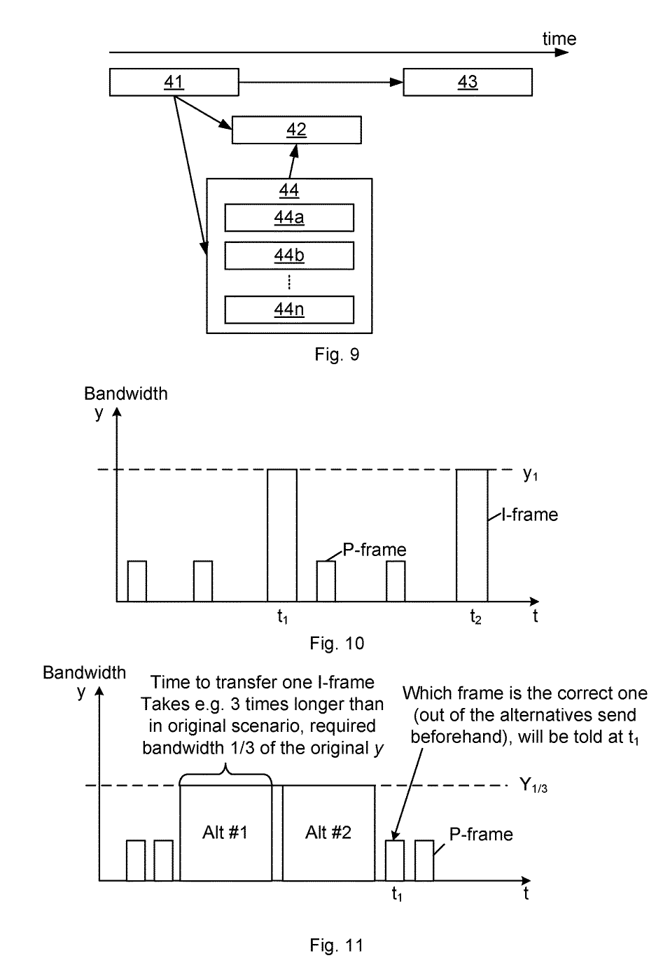

The sharing device 11 needs a starting point in order for the sharing device 11 to determine a candidate multimedia content segment for a future multimedia content segment. This starting point is given by a current multimedia content segment of the screen sharing application 13a executed by the sharing device 11 and/or a current state of the screen sharing application 13a executed by the sharing device 11. Hence, the sharing device 11 is configured to, in a step S102, acquire at least one of a current multimedia content segment 41 (see, FIG. 9) and a current state of a screen sharing application 13a executed by the sharing device. The sharing device 11 may be configured to perform step S102 by executing functionality of the functional module 21a.

The sharing device 11 then determines the candidate multimedia content segment. Particularly, the sharing device 11 is configured to, in a step S104, determine a candidate multimedia content segment 42 for a future multimedia content segment 43 of the screen sharing application 13a. The sharing device 11 may be configured to perform step S104 by executing functionality of the functional module 21b. The candidate multimedia content segment 42 is determined before the future multimedia content segment 43 is rendered at the sharing device 11. The candidate multimedia content segment is based on at least one of the current multimedia content segment 41 and the current state of the screen sharing application 13a and is determined from a limited set 44 of possible candidate multimedia content segments 44a, 44b, . . . 44n. Thus, the candidate multimedia content segment may be based on the current multimedia content segment 41 of the screen sharing application 13a, or on the current state of the screen sharing application 13a, or on both the current multimedia content segment 41 and the current state of the screen sharing application 13a.

Further, although a candidate multimedia content segment 42 is determined in step S104, one or more candidate multimedia content segments 42 may be determined based on at least one of the current multimedia content segment 41 and the current state of the screen sharing application 13a and from the limited set 44 of possible candidate multimedia content segments 44a, 44b, . . . 44n. Thus, hereinafter any reference to the candidate multimedia content segment 42 should be interpreted to at least one candidate multimedia content segment 42.

Once the candidate multimedia content segment 42 has been determined it is generated, encoded and (possibly, based on a condition) sent. Particularly, the sharing device 11 is configured to, in a step S106, generate and encode the candidate multimedia content segment 42. The sharing device 11 may be configured to perform step S106 by executing functionality of the functional module 21c. The sharing device 11 is configured to, in a step S110, send the generated and encoded candidate multimedia content segment 42 to a receiving device 12. The sharing device 11 may be configured to perform step S110 by executing functionality of the functional module 21d. The multimedia content segment 42 is sent before the future multimedia content segment 43 is rendered at the sharing device 11.

Reference is made to FIG. 9 schematically illustrating transmission of multimedia segments according to embodiments. Particularly, FIG. 9 illustrates how a candidate multimedia content segment 42 depends on a current multimedia content segment and limited set 44 of possible candidate multimedia content segment 44a, 44b, . . . , 44n, where n is the number of possible candidate multimedia content segments in the set 44. As mentioned above, the candidate multimedia content segment 42 may additionally or alternatively be based on the current state of the screen sharing application 13a. As further mentioned above, there may be more than one candidate multimedia segments 42. As will be further disclosed below there are different ways of determining candidate multimedia content segment 42 from the set 44 and also how to determine the set of possible candidate multimedia content segment 44a, 44b, . . . , 44n.

Reference is made to FIGS. 10 and 11 schematically illustrating transmission of multimedia segments according to embodiments. FIG. 10 shows the bandwidth usage of a typical screen sharing application which does not benefit from the embodiments as herein disclosed. When there is a substantial change (e.g., at t₁ and t₂) in the content, an I-frame is sent. The I-frame consumes substantially more bandwidth than the P-frames that are sent for smaller changes and results in traffic peaks whenever there is a change in the content.

In comparison, FIG. 11 shows bandwidth usage based on herein disclosed embodiments. The sharing device 11 anticipates a substantial change to happen (at t₁) and therefore renders at least one (two in the illustrated example) probable candidate multimedia segment (in this case two I-frame candidates) and transfers this/these to the receiving device 12. Since there is still time before t₁, the sharing device 11 may transfer the I-frames at a lower bitrate (in this case, ⅓ of the bandwidth of the scenario illustrated in FIG. 10). At t₁ the sharing device 11 knows which was the true future multimedia segment (I-frame) and, as will be further disclosed below, may send that information along with an optional difference, such as a P-frame, that tells the difference, if any, compared to the previously sent candidate multimedia segment.

For example, a (new) payload format of the Real Time Protocol (RTP) could be used to send the candidate multimedia content segment 42 and any required metadata (such as indexes used to reference to the selected candidate multimedia content segment 42).

Embodiments relating to further details of sharing multimedia content as performed by a sharing device 11 will now be disclosed.

Reference is now made to FIG. 5 illustrating methods for sharing multimedia content as performed by a sharing device 11 according to further embodiments.

Once the current multimedia content segment is acquired in step S102 it may already have been sent to the receiving device 12. If not, the current multimedia content segment may be sent to the receiving device 12. Particularly, the sharing device 11 may be configured to, in an optional step S108, send the current multimedia content segment to a receiving device. The sharing device 11 may be configured to perform step S108 by executing functionality of the functional module 21d.

There may be different ways to determine the candidate multimedia content segment 42 as in step S104. Different embodiments relating thereto will now be described in turn.

For example, determination of the candidate multimedia content segment 42 may be based on speaker parameter(s). The speaker parameter(s) may be associated with a video conference application. Hence, the screen sharing application 13a may be a video conference application. Particularly, determining the candidate multimedia content segment 42 may be based on a voice activity detection parameter associated with the screen sharing application 13a. The voice activity detection parameter may indicate the second most loudest speaker, the most overall active speaker, and/or a speaker pattern. In a video conference application a video of the current most loudest speaker may be shown in a full screen format whereas videos of the other speakers may be shown in a thumbnail format. For example, if the most loudest speaker is associated with the current multimedia segment 41, there is a probability that the next speaker will be the second most loudest speaker and hence the candidate multimedia segment 42 may be determined as a multimedia segment associated with the second most loudest speaker. For example, if the most loudest speaker is associated with the current multimedia segment 41, there is a high probability that the next speaker will be the most overall active speaker and hence the candidate multimedia segment 42 may be determined as a multimedia segment associated with the most overall active speaker. For example, if a speaker pattern (for example representing a particular order in which different speakers are active), the candidate multimedia segment 42 may be determined as a multimedia segment associated with the next speaker according to the speaker pattern.

The determination of the candidate multimedia content segments 42 may additionally or alternatively be based on a predicted next action. The next action may represent an application behaviour and/or a user behaviour. Particularly, the sharing device 11 may be configured to, in an optional step S104a, determine a probabilistic prediction of a next action of the screen sharing application 13a based on at least one of the current multimedia content segment 41 and the current state of the screen sharing application; and, in an optional step S104b, determine the candidate multimedia content segment 42 based on the next action. The sharing device 11 may be configured to perform step S104a and step S104b by executing functionality of the functional module 21b. For example, in order to know what I-frames to send, the sharing device 11 may perform a probabilistic prediction of the application's (and/or user's) behavior. The most probable future frames may then be rendered and encoded (but not shown to the local user of the sharing device 11) and sent to the receiving device 12 before the change happens locally at the application 13a of the sharing device 11.

There may be different ways to determine whether the candidate multimedia segment 42 should be sent to the receiving device 12 or not. Different embodiments relating thereto will now be described in turn. For example, if the probability that the candidate multimedia content segment 42 will be rendered at the sharing device 11 is too low, then it may be advantageous not to send the candidate multimedia content segment 42. This may be the case where it is difficult to determine a suitable set 44 of possible candidate multimedia content segments 44a, 44b, . . . , 44n. Particularly, the sharing device 11 may be configured to, in an optional step S104c, determine a probability of occurrence of the candidate multimedia content segment 12; and, in an optional step S110a, send the candidate multimedia content segment 42 if and only if the probability of occurrence is higher than a predetermined threshold value. The sharing device 11 may be configured to perform step S104c by executing functionality of the functional module 21b. The sharing device 11 may be configured to perform step S110a by executing functionality of the functional module 21d.

There may be different ways to determine the threshold value. Different embodiments relating thereto will now be described in turn.

For example, the predetermined threshold value may be based on initial transmission resources from the sharing device 11 to the receiving device 12. Thus, if there are a large number of transmission resources available, the threshold value may be set lower than if there only are a small number of transmission resources available.

An indication may be sent from the sharing device 11 to the rendering device 12 regarding if/when to render one of the candidate multimedia content segments 42. Particularly, the sharing device 11 may be configured to, in an optional step S112, indicate to the receiving device 12 at least one of if and when to render one of the candidate multimedia content segment 42. The sharing device 11 may be configured to perform step S112 by executing functionality of the functional module 21e.

If needed, a difference between the predicted future multimedia content segment, as represented by the candidate multimedia content segment 42, and the true future multimedia content segment (once available) may be sent to the receiving device 12 in order to improve the user experience at the receiving device 12. Particularly, the sharing device 11 may be configured to, in an optional step S114, determine a difference between the future multimedia content segment 43 and the candidate multimedia content segment 42; and, in an optional step S116, indicate the difference to the receiving device 12. The sharing device 11 may be configured to perform step S114 by executing functionality of the functional module 21b. The sharing device 11 may be configured to perform step S116 by executing functionality of the functional module 21d. The difference may be represented by a P-frame or B-frame. If at least two candidate multimedia content segments 42 are determined, the difference may be determined for all the at least two candidate multimedia content segments 42 and the candidate multimedia content segment 42 yielding the smallest difference may be indicated and the difference to that candidate multimedia content segment 42 may be indicated.

Thus, when the actual change happens locally at the application 13a of the sharing device 11, the sharing device 11 may compare the change to the transferred I-frames, select the best matching I-frame, send the index of that I-frame to the receiving device 12, and potentially send also a P- (or B-)frame describing the difference from the predicted frame (and the most probable following frame in case of a B-frame being sent).

As will be further disclosed below, the receiving device 12 may collect all predicted I-frames before rendering them and displaying them to the user and once it receives the index of the correct I-frame (and possibly a B/P-frame), it may render the correct image to the screen of the receiving device 12.

Once sent, there may be scenarios where it may be advantageous for the receiving device 12 to retain some or all of the candidate multimedia content segments 42. For example, this may be the case where the candidate multimedia content segments 42 represent frequently occurring multimedia segments or another multimedia content segment such as a menu screen, a table of content, a first/last slide, etc. which has a high probability of being rendered more than once. Hence, some of the candidate multimedia content segments 42 may comprise an indication that the candidate multimedia content segments 42 are to be retained by the receiving device 12 after having been rendered by the receiving device 12.

There may be different ways to determine how often to perform determination of new candidate multimedia content segments 42 and how many of them to generate each time. Different embodiments relating thereto will now be described in turn. For example, a frequency of occurrence for determining candidate multimedia content segments may be based on initial transmission resources from the sharing device 11 to the receiving device 12, screen sharing application parameters, and/or events of the screen sharing application. For example, if there are a large number of transmission resources from the sharing device 11 to the receiving device 12, new candidate multimedia content segments 42 may be determined more often or in larger quantity than if there are only a small number of transmission resources from the sharing device 11 to the receiving device 12. For example, if the screen sharing application more often changes screenshots, new candidate multimedia content segments 42 may be determined more often than if the screen sharing application less often changes screenshots.

There may be different examples of screen sharing applications. Different embodiments relating thereto will now be described in turn.

For a slide show presentation, the following, the previous, and perhaps the last slide would be potential candidates for preemptive sharing. Particularly, where the screen sharing application is a document application, the candidate multimedia content segment 42 may represent a next character, a next word, a next sentence, or a previously rendered multimedia content segment of the document application. The previously rendered multimedia content segment of the document application may for example be a previously rendered page of the document application. The document application may be a white board sharing application where the screen sharing application receives input from a electronic whiteboard at the sharing device 11.

For a game application, the result from the next most likely user action and the response from the game to that (e.g., a user moving forward and the game showing the view from that location) would be potential candidate for preemptive sharing. Particularly, when the screen sharing application is a computer implemented game application the candidate multimedia content segment may represent a game menu screen of the computer implemented game application.

When the screen sharing application is a video or audio application, such as a video conference application (see above), the candidate multimedia content segment may represent a future video or audio frame of the video or audio application. In general terms, most video codecs are based on three different kinds of frames when encoding a video stream: I (for Intra-coded picture), P (for Predicted picture) and B (for Bi-predictive picture) frames. When there is a substantial change in the encoded video, such as a next screenshot, an I-frame is used and after that P-frames can be sent that indicate the difference from the preceding frame or B-frames for the difference between preceding and following frame. The P- and B-frames contain less information than I-frames and hence consume less bandwidth when sent. Thus, according to at least some of the herein disclosed embodiments the sharing device 11 is enabled to determine, in a generic case, what is/are the likely next screenshot(s) or I-frame(s) that needs to be shown to the receiving device 12. These frames, as defined by the candidate multimedia segment 42, are rendered and transferred before the actual change happens locally at the sharing device 11 and once the change should be shown to the receiving device 12, only an indication which of the frames should be shown, and possibly the difference from that frame (using e.g., P-frame), needs to be sent from the sharing device 11. The video or audio frame may thus be a next screenshot, an intra-coded frame, or an instantaneous decoding refresh unit. A scenario of a screen sharing application where I-frames would need to be sent is when a slide of a presentation is changed or the application what is to be shared is changed or even when the speaker of a videoconference changes.

Reference is now made to FIG. 6 illustrating a method for sharing multimedia content as performed by a receiving device 12 according to an embodiment.

The receiving device 12 is configured to, in a step S202, receive a current multimedia content segment 41 of a screen sharing application 13a executed by the sharing device 11. The receiving device 12 may be configured to perform step S202 by executing functionality of the functional module 21f. To this end the receiving device 12 may also execute a screen sharing application 13b.

As noted above, the candidate multimedia content segment 42 is sent to the receiving device 12. Particularly, the receiving device 12 is configured to, in a step S204, receive a candidate multimedia content segment 42 for a future multimedia content segment 43 of the screen sharing application 13a. The receiving device 12 may be configured to perform step S204 by executing functionality of the functional module 21f. The candidate multimedia content segment 42 has been determined by the sharing device 11 based on at least one of the current multimedia content segment 41 and a current state of the screen sharing application 13a and from a limited set 44 of possible candidate multimedia content segments.

Again, although a candidate multimedia content segment 42 is received in step S204, one or more candidate multimedia content segments 42 may be determined based on at least one of the current multimedia content segment 41 and the current state of the screen sharing application 13a and from the limited set 44 of possible candidate multimedia content segments 44a, 44b, . . . 44n. Hence the receiving device 12 may in step S204 receive one or more candidate multimedia content segments 42. Thus, hereinafter any reference to the candidate multimedia content segment 42 should be interpreted to at least one candidate multimedia content segment 42.

Embodiments relating to further details of sharing multimedia content as performed by a receiving device 12 will now be disclosed.

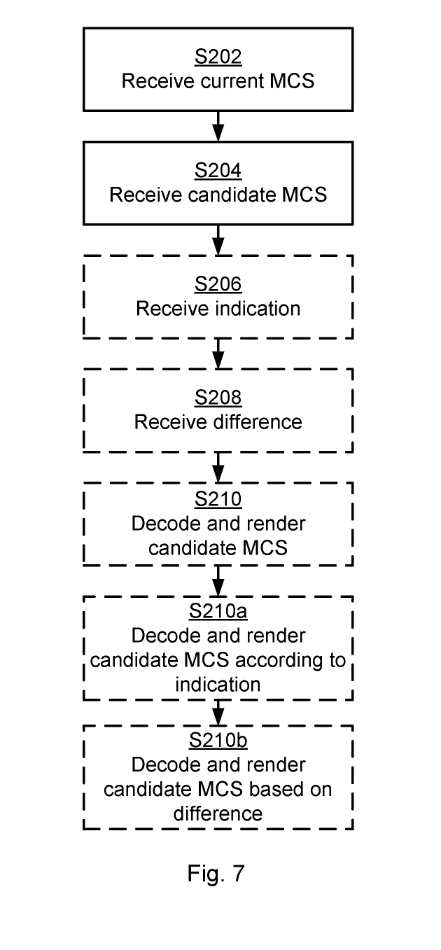

Reference is now made to FIG. 7 illustrating methods for sharing multimedia content as performed by a receiving device 12 according to further embodiments.

Once the candidate multimedia content segment 42 has been received, it may be decoded and rendered. Particularly, the receiving device 12 may be configured to, in an optional step S210, decode and render the candidate multimedia content segment 42. The receiving device 12 may be configured to perform step S210 by executing functionality of the functional module 21g.

As noted above, an indication may be sent from the sharing device 11 to the rendering device 12 regarding if/when to render the candidate multimedia content segment 42 (and if there are multiple candidate multimedia segments, which candidate multimedia segment to render). Therefore, the receiving device 12 may be configured to, in an optional step S206, receive an indication relating to at least one of if and when to render the candidate multimedia content segment 42 (and which candidate multimedia segment to render); and, in an optional step S210a, decode and render the candidate multimedia content segment 42 according to the indication. The receiving device 12 may be configured to perform step S206 by executing functionality of the functional module 21f. The receiving device 12 may be configured to perform step S210a by executing functionality of the functional module 21g.

As noted above, a difference between the predicted future multimedia content segment, as represented by the candidate multimedia content segment 42, and the true future multimedia content segment (once available) may be sent to the receiving device 12 in order to improve the user experience at the receiving device 12. Therefore, the receiving device 12 may be configured to, in an optional step S208, receive a difference between a future multimedia content segment 43 and the candidate multimedia content segment 42; and, in an optional step S210b, decode and render the future multimedia content segment 43 based on the candidate multimedia content segment 42 and the difference. The receiving device 12 may be configured to perform step S208 by executing functionality of the functional module 21f. The receiving device 12 may be configured to perform step S210b by executing functionality of the functional module 21g

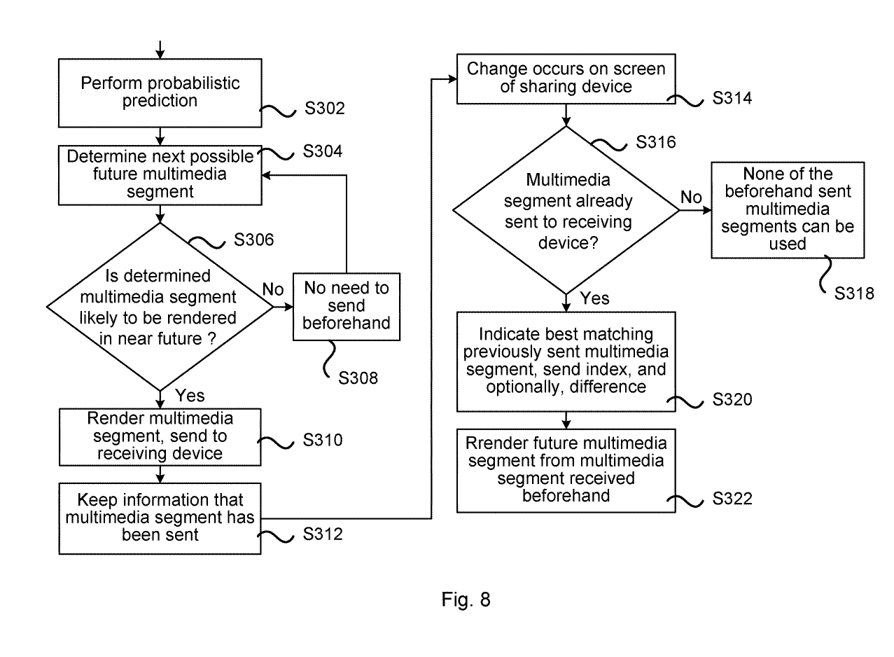

A particular embodiment based on at least some of the above disclosed embodiments will be described next with reference to the flowchart of FIG. 8.

S302: The sharing device 11 performs probabilistic prediction of the behavior of the screen sharing application 13a. One way to implement step S302 is to perform any of steps S102, S104, and S104a.

S304: The sharing device 11 determines a candidate multimedia segment 42. One way to implement step S304 is to perform any of step S104 and S104b.

S306: The sharing device 11 determines if the determined candidate multimedia segment 42 is likely to be rendered. If no, step S308 is entered, and if yes, step S310 is entered. One way to implement step S306 is to perform step S104c.

S308: The sharing device 11 has no need to send any candidate multimedia segment 42 beforehand.

S310: The sharing device 11 renders the candidate multimedia segment 42, and sends it to the receiving device 12 where it is received. One way to implement step S310 is to perform any of steps S106, S110, S110a, and S204.

S312: The sharing device 11 keeps information that the candidate multimedia segment 42 has been sent to the receiving device 12.

S314: The sharing device 11 acquires a notification that a change (resulting in a future multimedia segment 43 being rendered) has occurred at the screen sharing application 13a.

S316: The sharing device 11 checks if a corresponding candidate multimedia segment 42 (possibly with some variation) has already been sent to the receiving device 12. If no, step S318 is entered, and if yes, step S320 is entered.

S318: The sharing device 11 performs normal screen sharing by sending the future multimedia segment 43 since none of the beforehand sent candidate multimedia segments 42 can be used.

S320: The sharing device 11 indicates the best matching candidate multimedia segment 42, possibly, by sending the index of that candidate multimedia segment 42, and possibly sending a difference between the future multimedia segment 43 and the candidate multimedia segment 42 sent beforehand. This indication is received by the receiving device 12. One way to implement step S320 is to perform any of steps S112, S114, S116, S206, and S208.

S322: The receiving device 12 decodes and renders the candidate multimedia segment 42, possibly by using the difference between the future multimedia segment 43 and the candidate multimedia segment 42. One way to implement step S322 is to perform any of steps S210, S210a, and S210b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-24. (canceled)

25. A method for sharing multimedia content, the method being performed by a sharing device and comprising the steps of:
acquiring at least one of a current multimedia content segment and a current state of a screen sharing application executed by the sharing device;
determining, before a future multimedia content segment is rendered at the sharing device, a candidate multimedia content segment for said future multimedia content segment of the screen sharing application, wherein the candidate multimedia content segment is based on at least one of the current multimedia content segment and the current state of the screen sharing application and is determined from a limited set of possible candidate multimedia content segments;
generating and encoding the candidate multimedia content segment; and
sending the generated and encoded candidate multimedia content segment to a receiving device before the future multimedia content segment is rendered at the sharing device.

26. The method of claim 25, further comprising:
sending the current multimedia content segment to a receiving device.

27. The method of claim 25, further comprising:
indicating to the receiving device at least one of whether and when to render the candidate multimedia content segment.

28. The method of claim 25, further comprising:
determining a difference between the future multimedia content segment and the candidate multimedia content segment; and
indicating the difference to the receiving device.

29. The method of claim 25, further comprising:
determining a probabilistic prediction of a next action of the screen sharing application based on at least one of the current multimedia content segment and the current state of the screen sharing application; and
determining the candidate multimedia content segment based on the next action.

30. The method of claim 25, further comprising:
determining a probability of occurrence of the candidate multimedia content segment; and
sending the candidate multimedia content segment if and only if the probability of occurrence is higher than a predetermined threshold value.

31. The method of claim 30, wherein the predetermined threshold value is based on at least one of current and initial transmission resources from the sharing device to the receiving device.

32. The method of claim 25, wherein determining the candidate multimedia content segment is based on a voice activity detection parameter associated with the screen sharing application, such as second loudest speaker, most active speaker, and a speaker pattern.

33. The method of claim 25, wherein a frequency of occurrence for determining candidate multimedia content segments is based on at least one of initial transmission resources from the sharing device to the receiving device, screen sharing application parameters, and events of the screen sharing application.

34. The method of claim 25, wherein the candidate multimedia content segment comprises an indication that the candidate multimedia content segment is to be retained by the receiving device after having been rendered by the receiving device.

35. The method of claim 25, wherein the screen sharing application is a computer implemented game application and wherein the candidate multimedia content segment represents a game menu screen of the computer implemented game application.

36. The method of claim 25, wherein the screen sharing application is a video or audio application and wherein the candidate multimedia content segment represents a future video or audio frame of the video or audio application.

37. The method of claim 36, wherein the video or audio frame is a next screenshot, an intra-coded frame, or an instantaneous decoding refresh unit.

38. The method of claim 25, wherein the screen sharing application is a document application and wherein the candidate multimedia content segment represents a next character, a next word, a next sentence, or a previously rendered multimedia content segment of the document application.

39. The method of claim 38, wherein the previously rendered multimedia content segment of the document application is a previously rendered page of the document application.

40. A method for sharing multimedia content, the method being performed by a receiving device, comprising the steps of:
receiving a current multimedia content segment of a screen sharing application executed by a sharing device;
receiving a candidate multimedia content segment for a future multimedia content segment of the screen sharing application, the candidate multimedia content segment having been determined by the sharing device based on at least one of the current multimedia content segment and a current state of the screen sharing application and from a limited set of possible candidate multimedia content segments.

41. The method of claim 40, further comprising:
decoding and rendering the candidate multimedia content segment.

42. The method of claim 40, further comprising:
receiving an indication relating to at least one of whether and when to render the candidate multimedia content segment; and
decoding and rendering the candidate multimedia content segment according to the indication.

43. The method of claim 40, further comprising:
receiving a difference between a future multimedia content segment and the candidate multimedia content segment; and
decoding and rendering the future multimedia content segment based on the candidate multimedia content segment and the difference.

44. A sharing device for sharing multimedia content, the sharing device comprising a processing circuit, the processing circuit being configured to:
acquire a current multimedia content segment of a screen sharing application executed by the sharing device;
determine, before a future multimedia content segment is rendered at the sharing device, a candidate multimedia content segment for said future multimedia content segment of the screen sharing application, wherein the candidate multimedia content segment is based on at least one of the current multimedia content segment and the current state of the screen sharing application and is determined from a limited set of possible candidate multimedia content segments;
generate and encode the candidate multimedia content segment; and
send the generated and encoded candidate multimedia content segment to a receiving device before the future multimedia content segment is rendered at the sharing device.

45. A receiving device for sharing multimedia content, the receiving device comprising a processing circuit, the processing circuit being configured to:
receive a current multimedia content segment of a screen sharing application executed by a sharing device;
receive a candidate multimedia content segment for a future multimedia content segment of the screen sharing application, the candidate multimedia content segment having been determined by the sharing device based on at least one of the current multimedia content segment and a current state of the screen sharing application and from a limited set of possible candidate multimedia content segments.

46. A non-transitory computer-readable medium comprising, stored thereupon, a computer program for sharing multimedia content, the computer program comprising computer program code which, when run on a processing circuit of a sharing device causes the processing circuit to:
acquire at least one of a current multimedia content segment and a current state of a screen sharing application executed by the sharing device;
determine, before a future multimedia content segment is rendered at the sharing device, a candidate multimedia content segment for said future multimedia content segment of the screen sharing application, wherein the candidate multimedia content segment is based on at least one of the current multimedia content segment and the current state of the screen sharing application and is determined from a limited set of possible candidate multimedia content segments;
generate and encode the candidate multimedia content segment; and
send the generated and encoded candidate multimedia content segment to a receiving device before the future multimedia content segment is rendered at the sharing device.

47. A non-transitory computer-readable medium comprising, stored thereupon, a computer program for sharing multimedia content, the computer program comprising computer program code which, when run on a processing circuit of a receiving device causes the processing circuit to:
receive a current multimedia content segment of a screen sharing application executed by a sharing device;
receive a candidate multimedia content segment for a future multimedia content segment of the screen sharing application, the candidate multimedia content segment having been determined by the sharing device based on at least one of the current multimedia content segment and a current state of the screen sharing application and from a limited set of possible candidate multimedia content segments.
